(19) United States
(12) Patent Application Publication
(10) Pub. No.: US 2007/0212020 A1
(43) Pub. Date: Sep. 13, 2007

(54) Timer reservation device and information recording apparatus

(75) Inventor: Makoto Takemoto, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/708,907

(22) Filed: Feb. 22, 2007

(30) Foreign Application Priority Data
Mar. 2, 2006 (JP) 2006-055968

(51) Int. Cl. H04N 5/91

(52) U.S. Cl. 386/83

(57) ABSTRACT

A timer reservation device includes a control portion for extracting broadcasting programs that match entered contents from broadcasting programs obtained by the broadcasting program obtaining portion when any one of items that are necessary for the timer reservation, such as record start date, record start time, record end time, and channel information, is entered by the input portion and for making a display portion display the extracted broadcasting programs, the control portion extracts broadcasting programs in each case when an item that is necessary for the timer reservation is added by the input portion and makes the display portion display the extracted broadcasting programs that match entered contents till the moment, and if the program desired for the recording reservation is found within the displayed program list, the program is selected to complete the recording reservation.

This application is based on Japanese Patent Application No. 2006-055968 filed on Mar. 2, 2006, the contents of which are hereby incorporated by reference.

### BACKGROUND OF THE INVENTION

1. Field of the Invention

The present invention relates to a timer reservation device and an information recording apparatus.

2. Description of Related Art

Typical methods for a user to perform recording reservation by using a recording apparatus such as a video cassette recorder that is capable of recording television (TV) programs include the following three methods. A first method is the timer reservation in which date, start time, end time, channel information and the like are entered for the recording reservation.

A second method is a G-code reservation in which a G-code is entered for the recording reservation. The G-code is printed on newspapers, TV information magazines or the like, and the G-code includes encoded information of date, start time, end time and channel information of each program. A third method is an EPG reservation in which a program list called an electronic program guide (EPG) is displayed on a TV screen for a user to select a desired program for the recording reservation.

Among these methods, the timer reservation has an advantage in that if a user remembers date, start time, end time and channel information of a program to be recorded completely, the user can save a labor of checking the G-code and entering the same or a labor of displaying the EPG and searching a program to be recorded, so the timer reservation can be said to be most convenient among the above-mentioned three methods.

However, the timer reservation requires the user to set more items than the G-code reservation or the EPG reservation does. More specifically, it is necessary to enter date, start time, end time and channel information. Therefore, the timer reservation is apt to cause an error compared with the G-code reservation or the EPG reservation in which a title of a program can be confirmed when the reservation is performed.

JP-A-2005-051325 describes an invention to counter such a problem, which is related to an information processing apparatus having a function of referring to the EPG when three items out of date, start time, end time and a channel number are entered for the timer reservation so as to estimate a corresponding program and displaying the estimated program on a timer reservation screen.

According to the invention described in JP-A-2005-051325, when the user enters only three items out of date, start time, end time and a channel number that are necessary for the timer reservation, a program desired by the user is estimated and is displayed. Therefore, it is possible to provide an information processing apparatus that can simplify operations for the timer reservation and can prevent an operational error of the user in the timer reservation operation.

The information processing apparatus described in JP-A-2005-051325 estimates the corresponding program by referring the EPG when three items out of date, start time, end time and a channel number are entered for the timer reservation and displays the estimated program on the timer reservation screen. However, there can be the situation where the user remembers date and start time but does not remember end time and channel number, in many cases. In this case, it is necessary for the user to enter uncertain end time or channel number so that an estimated program is displayed on the timer reservation screen or to confirm the end time or the channel number by referring to a program list on a newspaper or the like. This situation is inconvenient.

### SUMMARY OF THE INVENTION

In view of the above described problems, it is an object of the present invention to provide a timer reservation device that enables easy and correct timer reservation even if a user remembers only a part of information that is necessary for the timer reservation. And it is another object of the present invention is to provide an information recording apparatus that is capable of recording reservation by using the timer reservation device.

To attain the above described first object, a timer reservation device in accordance with one aspect of the present invention includes: an input portion for entering items that are necessary for timer reservation; a timer reservation setting portion for performing the timer reservation based on input by the input portion; a broadcasting program obtaining portion for obtaining broadcasting programs; and a control portion for extracting broadcasting programs that match entered contents from broadcasting programs obtained by the broadcasting program obtaining portion when any one of items that are necessary for the timer reservation is entered by the input portion and for making a display portion display the extracted broadcasting programs.

According to this structure, the control portion extracts broadcasting programs that match entered contents when any one of items (e.g., date, start time, end time and channel information) that are necessary for the timer reservation is entered by the input portion, and the control portion makes the display portion display the extracted broadcasting programs. Therefore, even in the situation where the user remembers only date of a program to be a target of the recording reservation but does not remember start time, end time and a channel number thereof, broadcasting programs that match the date are displayed when the date is entered. Therefore, the user can enter other items to be set that are start time, end time and channel information while seeing the broadcasting programs. Thus, it is possible to provide a timer reservation device that enables easy and correct timer reservation even if a user remembers only any one of items that are necessary for the timer reservation. At this point, the timer reservation device having the structure described above is effective particularly in recording reservation by an information recording apparatus and in receiving reservation by a television set. At this point, the display portion described above may be built in the timer reservation device or may be an external display portion.

In the present invention, as to the timer reservation device having the structure described above, it is preferable that the control portion extracts broadcasting programs in each case when an item that is necessary for the timer reservation is added by the input portion and makes the display portion display the extracted broadcasting programs that match entered contents till the moment.

According to this structure, the control portion extracts broadcasting programs that match entered contents as items that are necessary to for the timer reservation are added one by one by the input portion, and the extracted broadcasting programs are displayed on the display portion that match entered contents till the moment. Therefore, even in the situation where the user remembers date and start time of a program to be a target of the recording reservation but does not remember end time and a channel number for example, broadcasting programs that match the date and the start time are displayed when the date and the start time are entered. Therefore, the user can enter other items to be set that are end time and channel information while seeing the broadcasting programs. Thus, it is possible to provide a timer reservation device that enables easy and correct timer reservation even if a user remembers only a part of items that are necessary for the timer reservation.

In the present invention, as to the timer reservation device having the structure described above, it is preferable to include a selecting portion for selecting a program from broadcasting programs displayed on the display portion and a selected program reservation setting portion for performing reservation of the selected program when the program is selected by the selecting portion from the broadcasting programs displayed on the display portion.

According to this structure, the selected program reservation setting portion performs reservation of the selected program when the program is selected from the broadcasting programs displayed on the display portion. Therefore, even in the situation where the user remembers date and start time of a program to be a target of the recording reservation but does not remember end time and a channel number for example, broadcasting programs that match the date and the start time are displayed when the date and the start time are entered. When a program to be a target of the recording reservation is selected from the broadcasting programs, the recording reservation can be performed. Thus, it is possible to provide a timer reservation device that enables easy and correct timer reservation even if a user remembers only a part of items that are necessary for the timer reservation.

To attain the above described second object, an information recording apparatus in accordance with another aspect of the present invention includes: the timer reservation device which has the structure described above and a timer recording portion for recording information on a recording medium at the time reserved by the timer reservation device.

According to this structure, the information recording apparatus can perform recording reservation by using the timer reservation device having the structure described above. Therefore, the information recording apparatus enables easy and correct recording reservation even if a user remembers only a part of information that is necessary for the timer reservation. At this point, the display portion may be built in the information recording apparatus or may be an external display portion.

To attain the above described second object, an information recording apparatus in accordance with other aspect of the present invention includes: a timer reservation device: and a timer recording portion for recording information on a recording medium at the time reserved by the timer reservation device. And the information recording apparatus is characterized by a structure in which the timer reservation device includes an input portion for entering items that are necessary for timer reservation, a timer reservation setting portion for performing the timer reservation based on input by the input portion, a broadcasting program obtaining portion for obtaining broadcasting programs, a control portion for extracting broadcasting programs that match entered contents from broadcasting programs obtained by the broadcasting program obtaining portion when any one of items that are necessary for the timer reservation is entered by the input portion so as to make a display portion display the same, and for extracting broadcasting programs in each case when an item that is necessary for the timer reservation is added by the input portion and makes the display portion display the extracted broadcasting programs that match entered contents till the moment, a selecting portion for selecting a program from broadcasting programs displayed on the display portion, and a selected program reservation setting portion for performing reservation of the selected program when the program is selected by the selecting portion from broadcasting programs displayed on the display portion.

According to this structure, it is possible to provide an information recording apparatus that enables easy and correct recording reservation even if a user remembers only a part of information that is necessary for the timer reservation.

According to the present invention, it is possible to provide a timer reservation device that enables easy and correct timer reservation even if a user remembers only a part of information that is necessary for the timer reservation. In addition, according to the present invention, it is possible to provide an information recording apparatus that enables recording reservation by using the timer reservation device.

### BRIEF DESCRIPTION OF THE DRAWINGS

FIG. 1 is a block diagram to show a structure of a DVD recorder according to an embodiment of the present invention.

FIG. 2 is an explanatory diagram to show a setting screen for timer reservation according to the embodiment of the present invention.

FIG. 3 is an explanatory diagram to show the setting screen for the timer reservation in which December 12 is entered as record start date.

FIG. 4 is an explanatory diagram to show the setting screen for the timer reservation in which December 12 as the record start date and 15:00 as record start time are entered.

FIG. 5 is an explanatory diagram to show the setting screen for the timer reservation in which December 12 as the record start date, the record start time 15:00 and record end time 16:00 are entered.

FIG. 6 is an explanatory diagram to show the setting screen for the timer reservation in which December 12 as the record start date, the record start time 15:00, the record end time 16:00 and 5 CH as channel information are entered.

### DETAILED DESCRIPTION OF THE PREFERRED EMBODIMENTS

An embodiment of the present invention will be described with reference to the attached drawings.

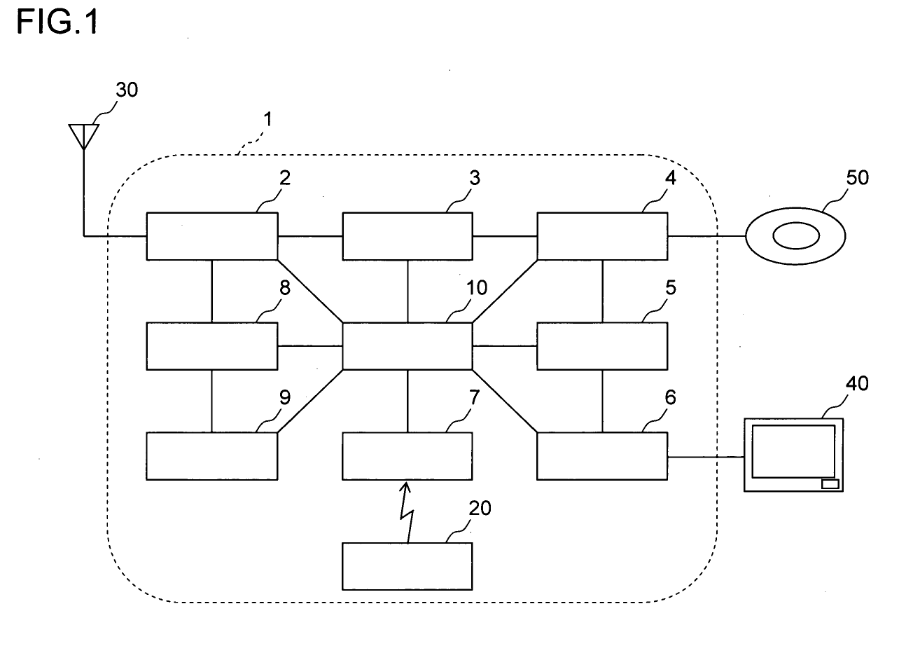

A DVD recorder is exemplified in the following description. FIG. 1 is a block diagram to show a structure of a DVD recorder 1 (an information recording apparatus) according to an embodiment of the present invention. At this point, FIG. 1 shows only a structure that is necessary for the present invention, and other structure that is unnecessary to be described for the present invention is omitted. The DVD recorder 1 includes a tuner 2, an MPEG encoder 3, a DVD drive 4, an MPEG decoder 5, an on screen display (OSD) portion 6, a light receiving portion 7, an EPG obtaining device 8 (a broadcasting program obtaining portion), a reservation memory 9, a CPU 10 (a timer reservation setting portion, a control portion and a selected program reservation setting portion) and a remote controller 20 (an input portion and a selecting portion).

At this point, the remote controller 20 is portable independently of a main body of the DVD recorder. Furthermore, the tuner 2 is connected to an antenna 30, and the OSD portion 6 is connected to a television set 40 (a display portion). In addition, the DVD drive 4 is loaded with a DVD 50 (a recording medium) as a recording medium on which information is recorded and reproduced.

Using the DVD recorder 1 according to the present embodiment, broadcasting information is recorded on the DVD 50 by the flow of processes as described below. First, a broadcasting signal of a desired channel is selected by the tuner 2 from broadcasting signals received by the antenna 30. Next, the MPEG encoder 3 performs encoding (compression), and the DVD drive 4 performs recording on the DVD 50.

Furthermore, using the DVD recorder 1 according to the present embodiment, information recorded on the DVD 50 is reproduced by the flow of processes as described below. First, the DVD drive 4 reads out a digital record signal recorded on the DVD 50, and this digital record signal is sent to the MPEG decoder 5. Next, the MPEG decoder 5 performs decoding of the digital record signal, and an output signal thereof is sent to the television set 40 via the OSD portion 6. Then, the television set 40 produces pictures and sounds.

The light receiving portion 7 receives an infrared signal from the remote controller 20 corresponding to various instructions made by operation of a plurality of input keys provided to the remote controller 20, and the light receiving portion 7 converts the infrared signal into an electric signal that is sent to the CPU 10.

The EPG obtaining device 8 extracts a character signal that is superimposed on a broadcasting wave and is sent out, and the EPG obtaining device 8 obtains EPG data as the broadcasting program so as to store the obtained EPG data. The EPG data includes information such as a title of the program, broadcasting date, broadcasting start time, broadcasting end time, a reservation code, channel information, a genre of the program and the like for approximately two weeks.

The reservation memory 9 is a memory that stores information concerning the recording reservation that is set at that time point.

The CPU 10 is connected to the tuner 2, the MPEG encoder 3, the DVD drive 4, the MPEG decoder 5, the OSD portion 6, the light receiving portion 7, the EPG obtaining device 8 and the reservation memory 9, and the CPU 10 supplies control instruction signals to them so that they perform various operations.

Next, an operation of the DVD recorder 1 of the present embodiment as the DVD recorder 1 performs recording with the recording reservation will be described. The CPU 10 monitors the information concerning the recording reservation stored in the reservation memory 9 and makes the tuner 2 select the broadcasting signal of a channel to be recorded when the record start time comes. Then, the broadcasting signal is encoded by the MPEG encoder 3, and the obtained record signal is recorded on the DVD 50 by the DVD drive 4. Then, the CPU 10 stops these operations when the record end time comes.

In other words, the DVD drive 4, the reservation memory 9 and the CPU 10 constitute a timer recording portion, which records information on the DVD 50 at the time reserved by the timer reservation device that will be described later.

Next, an operation of setting the timer reservation of recording by using the DVD recorder 1 of the present embodiment will be described. When a timer reservation record button (not shown) that is provided to the remote controller 20 is pressed, an infrared signal that corresponds to the timer reservation record button is sent from the remote controller 20 to the light receiving portion 7. When the light receiving portion 7 receives the infrared signal, the light receiving portion 7 converts the infrared signal into an electric signal, which is sent to the CPU 10.

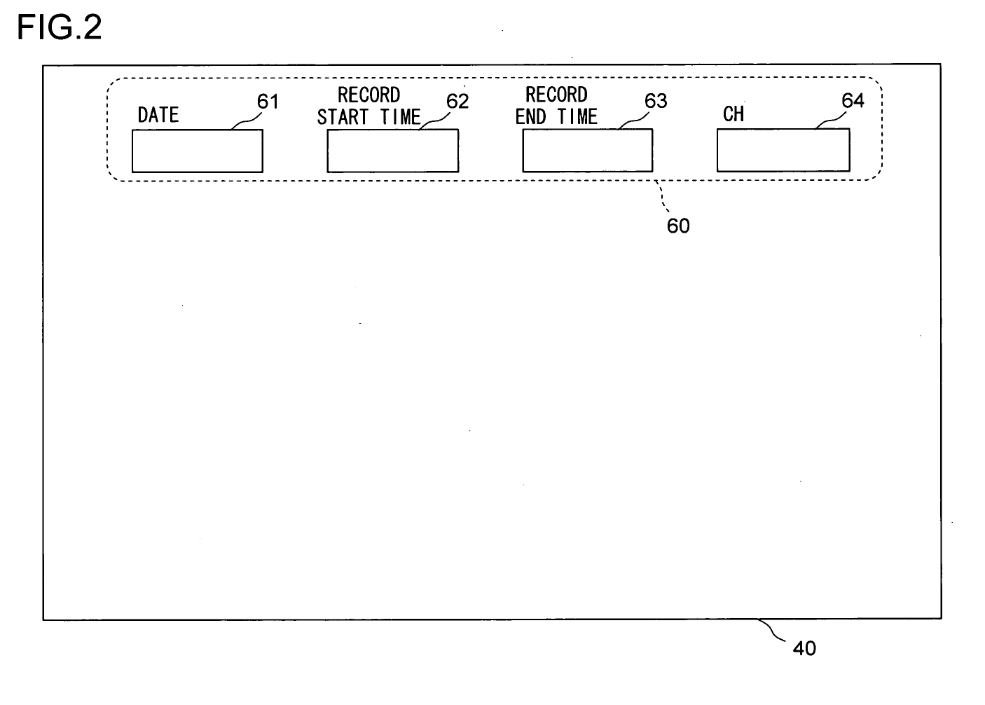

Then, the CPU 10 instructs the OSD portion 6 to display a setting screen for the timer reservation. Then, the OSD portion 6 generates an OSD signal concerning the setting screen for the timer reservation and makes the television set 40 display the setting screen for the timer reservation. At this time point, the television set 40 displays the setting screen for the timer reservation as shown in FIG. 2. In the upper part of this screen, a timer reservation setting portion 60 is disposed. The timer reservation setting portion 60 includes a record start date input portion 61, a record start time input portion 62, a record end time input portion 63 and a channel input portion 64, respectively.

Then, a user operates the remote controller 20 so as to enter record start date, record start time, record end time and channel information on the screen so that the timer reservation is performed. When these inputs are performed, the OSD signal that was generated before is updated sequentially. As a result, the display screen of the television set 40 is updated sequentially. In addition, when the timer reservation is completed, the CPU 10 issues an instruction so that the information of the timer reservation concerning the record start date, the record start time, the record end time and the channel information is stored in the reservation memory 9.

Recently, convenient recording reservation methods except for the timer reservation are coming into wide use, which includes G-code reservation, EPG reservation and the like. In the G-code reservation method, a user inputs a G-code for the recording reservation that is printed on newspapers, TV information magazines or the like and contains encoded information of date, start time, end time and channel information corresponding to each program. In the EPG reservation, a program list called an electronic program guide (EPG) is displayed on a TV screen for a user to select a desired program for the recording reservation.

The timer reservation has an advantage in that if a user remembers date, start time, end time and channel information of a program to be recorded completely, the user can save a labor of checking the G-code and entering the same or a labor of displaying the EPG and searching a program to be recorded, so the timer reservation is convenient compared with these recording reservation methods.

However, in the conventional DVD recorder, if the user does not remember all of date, start time, end time and channel information of a program to be recorded completely, the user has to check information by referring to a newspaper, a TV information magazine or the like for performing the timer reservation. In addition, the timer reservation requires a user to set more items than the G-code reservation or the EPG reservation does, so the timer reservation is apt to cause an input error.

Therefore, in the case of the DVD recorder 1 according to the present embodiment, the CPU 10 searches EPG data that is stored in the EPG obtaining device 8 when any one of record start date, record start time, record end time and channel information is entered in the timer reservation setting portion 60 of the setting screen for the timer reservation, and the entering information makes the setting screen for the timer reservation display a program list (broadcasting programs) corresponding to the input.

In addition, in the DVD recorder 1 according to the present embodiment, when a second or following item among the record start date, the record start time, the record end time and the channel information is entered in the timer reservation setting portion 60 of the setting screen for the timer reservation, the CPU 10 searches EPG data that is stored in the EPG obtaining device 8 and makes the setting screen for the timer reservation display a program list (broadcasting programs) corresponding to the input till the moment.

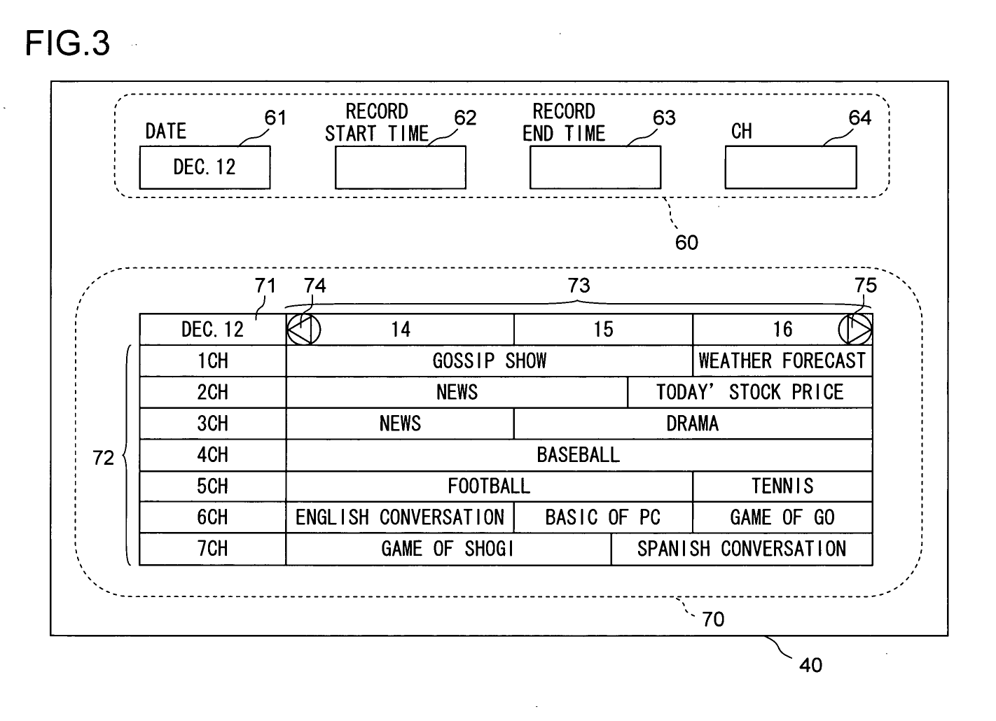

For example, it is supposed that the user enters “Dec. 12” in the record start date input portion 61 first. In this case, the setting screen for the timer reservation becomes as shown in FIG. 3. More specifically, as shown in the screen shown in FIG. 3, a program list is displayed in a program list display portion 70 adding to the display of the timer reservation setting portion 60.

The program list that is displayed in the program list display portion 70 includes a date display portion 71, a channel axis 72, a time axis 73 and time axis scroll buttons 74 and 75. When the time axis scroll button 74 or 75 is pointed, a time zone of the program list that is displayed in the program list display portion 70 is scrolled.

At this point, only the record start date “Dec. 12” is entered in the timer reservation setting portion 60 at this time point. In this case, the program list display portion 70 displays the program list of a specific time zone (between 14:00 and 17:00 in this example), which can be scrolled by using the time axis scroll buttons 74 and 75. Alternatively, it is possible to display a program list including all programs on Dec. 12 although a size of characters in the program list may become very small.

At this point, when only the record start date is entered, the time zone of the program list that is displayed first is selected to be a time zone corresponding to the time when setting of the timer reservation is being performed or the like. In addition, when the user finds the program to be a target of the recording reservation in the program list and selects the program, the CPU 10 makes the reservation memory 9 store the recording reservation information corresponding to the program and completes the recording reservation of the program.

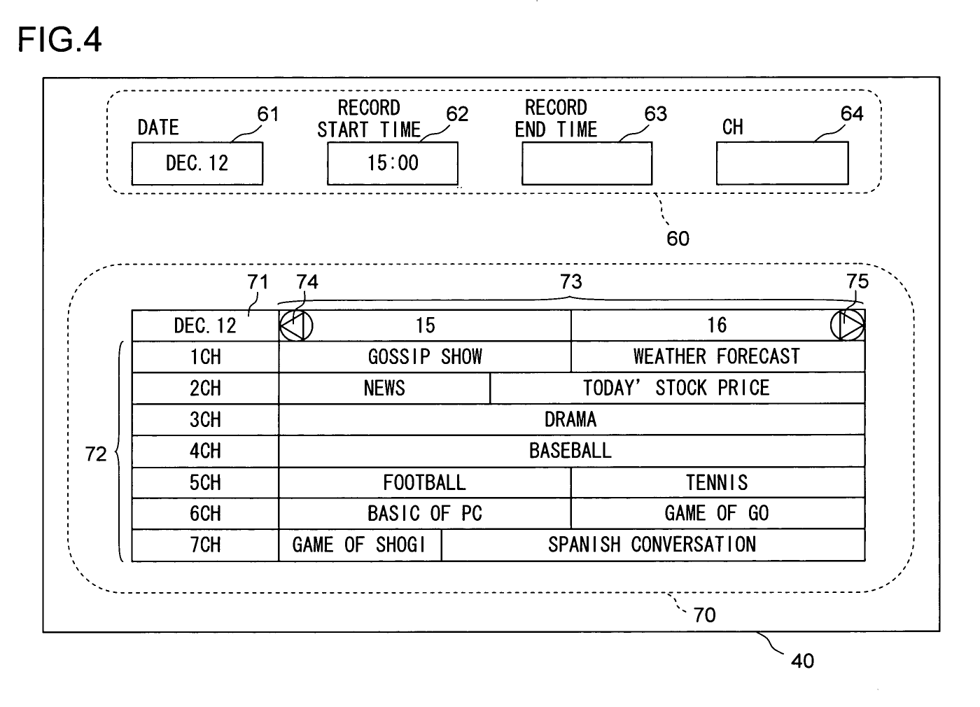

Next, it is supposed that the user enters “15:00” in the record start time input portion 62. In this case, the setting screen for the timer reservation becomes as shown in FIG. 4. More specifically, in the screen shown in FIG. 4, the time zone of the program list displayed in the program list display portion 70 becomes a time zone from 15:00 to the latest time when the programs starting at 15:00 or being broadcasted at 15:00 end (17:00 in this example). Also in this case, when the user finds the program to be a target of the recording reservation in the program list and selects the program, the CPU 10 makes the reservation memory 9 store the recording reservation information corresponding to the program and completes the recording reservation of the program.

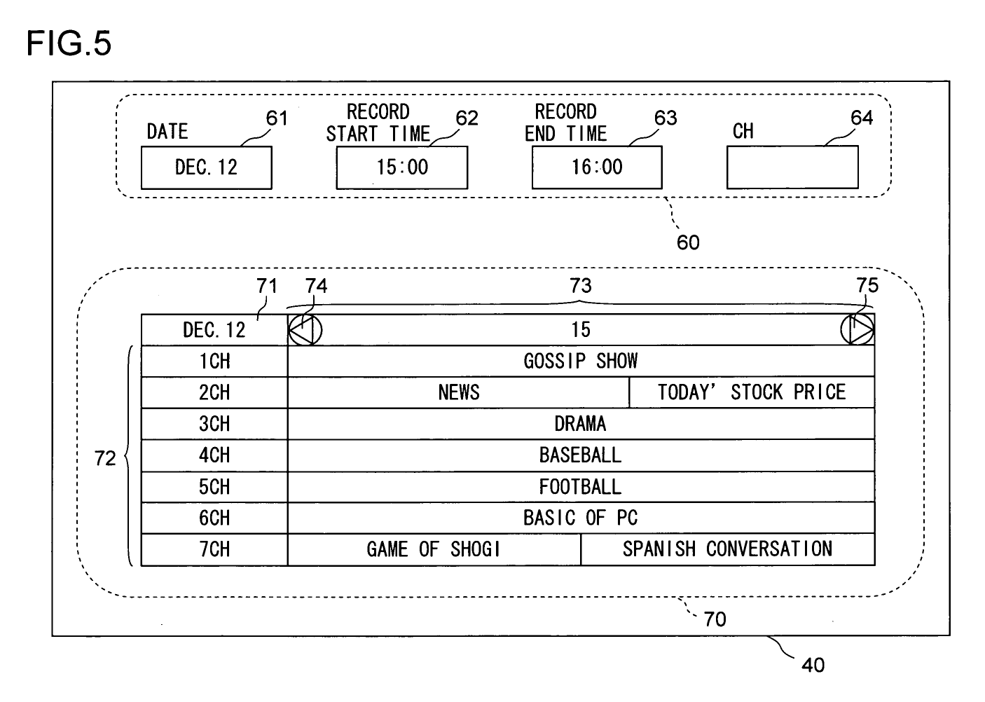

Next, it is supposed that the user enters “16:00” in the record end time input portion 63. In this case, the setting screen for the timer reservation becomes as shown in FIG. 5. More specifically, in the screen shown in FIG. 5, the time zone of the program list displayed in the program list display portion 70 becomes a time zone from 15:00 to 16:00. Also in this case, when the user finds the program to be a target of the recording reservation in the program list and selects the program, the CPU 10 makes the reservation memory 9 store the recording reservation information corresponding to the program and completes the recording reservation of the program.

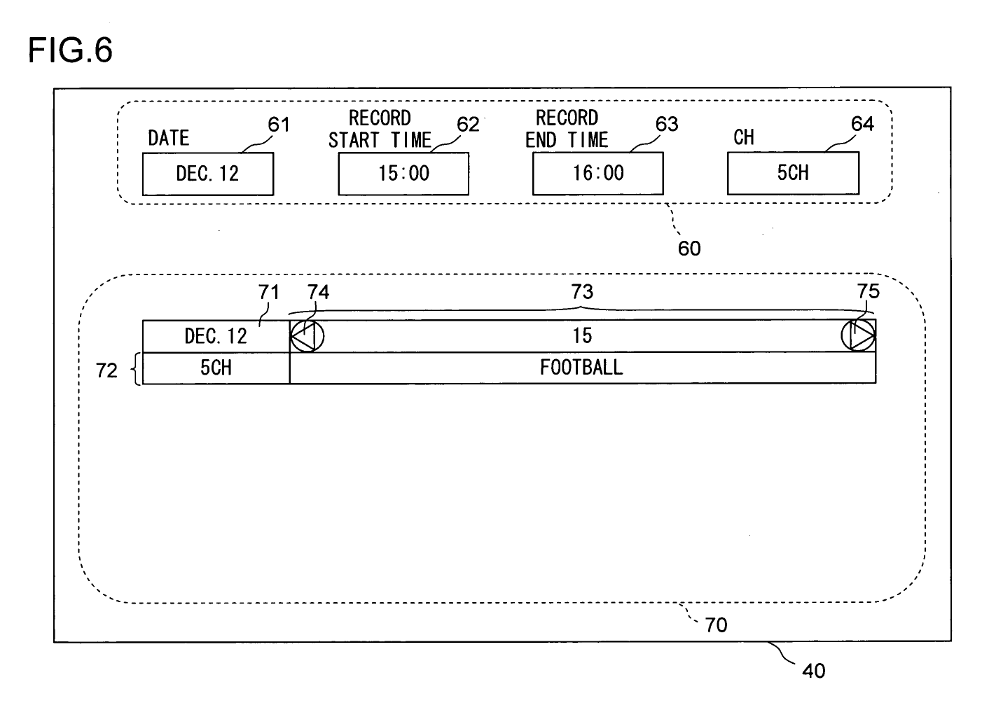

Next, it is supposed that the user enters “5 CH” in the channel input portion 64. In this case, the setting screen for the timer reservation becomes as shown in FIG. 6. More specifically, in the screen shown in FIG. 6, the program list displayed in the program list display portion 70 has a time zone from 15:00 to 16:00 and only a part of 5 CH (only a program of a football in this example).

As described above, the light receiving portion 7, the EPG obtaining device 8, the reservation memory 9, the CPU 10 and the remote controller 20 constitute the timer reservation device for performing the timer reservation.

According to the structure describe above, as to the DVD recorder 1, when any one of record start date, record start time, record end time and channel information is entered in the timer reservation setting portion 60 of the setting screen for the timer reservation, the CPU 10 searches EPG data that is stored in the EPG obtaining device 8 and makes the setting screen for the timer reservation display a program list corresponding to the input.

In addition, as to the DVD recorder 1, when a second or following item among the record start date, the record start time, the record end time and the channel information is entered in the timer reservation setting portion 60 of the setting screen for the timer reservation, the CPU 10 searches EPG data that is stored in the EPG obtaining device 8 and makes the setting screen for the timer reservation display a program list corresponding to the input till the moment.

Therefore, even in the situation where the user remembers date and start time of a program to be a target of the recording reservation but does not remember end time and a channel number for example, a program list that matches the date and the start time is displayed in the setting screen when the date and the start time are entered. Thus, the user can enter other items to be set that are end time and channel information while seeing the program list. Therefore, it is possible to provide a timer reservation device that enables easy and correct reservation even if a user remembers only a part of information that is necessary for the timer reservation.

In addition, as to the DVD recorder 1 according to the present embodiment, if a program to be a target of the recording reservation is found in the program list displayed in the program list display portion 70, the program is selected to complete the recording reservation of the program. Therefore, even in the situation where the user remembers date and start time but does not remember end time and a channel number, a program list that matches the date and the start time is displayed in the setting screen when the date and the start time are entered. Thus, when a program to be a target of the recording reservation in the program list is selected, the recording reservation is performed.

As a result, if the user remembers a part of information that is necessary for the timer reservation, the user can save a labor of checking the G-code and entering the same or a labor of displaying the EPG and searching a program to be recorded, so that the recording reservation can be performed correctly and conveniently.

At this point, the present invention is not limited to the embodiment described above, and the structure thereof can be modified variously within the spirit and the scope of the present invention. For example, although the embodiment described above is related to the DVD recorder, the present invention can be applied also to recording reservation by a video cassette recorder, a hard disk recorder or the like in the same way. In addition, the present invention can be applied also to receiving reservation by a television set in the same manner.

The present invention is effective as a timer reservation device and an information recording apparatus.

What is claimed is:

1. A timer reservation device comprising:
an input portion for entering items that are necessary for timer reservation;
a timer reservation setting portion for performing the timer reservation based on input by the input portion;
a broadcasting program obtaining portion for obtaining broadcasting programs; and
a control portion for extracting broadcasting programs that match entered contents from broadcasting programs obtained by the broadcasting program obtaining portion when any one of items that are necessary for the timer reservation is entered by the input portion and for making a display portion display the extracted broadcasting programs.

2. The timer reservation device according to claim 1, wherein the control portion extracts broadcasting programs in each case when an item that is necessary for the timer reservation is added by the input portion and makes the display portion display the extracted broadcasting programs that match entered contents till the moment.

3. The timer reservation device according to claim 1, further comprising a selecting portion for selecting a program from broadcasting programs displayed on the display portion and a selected program reservation setting portion for performing reservation of the selected program when the program is selected by the selecting portion from broadcasting programs displayed on the display portion.

4. The timer reservation device according to claim 2, further comprising a selecting portion for selecting a program from broadcasting programs displayed on the display portion and a selected program reservation setting portion for performing reservation of the selected program when the program is selected by the selecting portion from broadcasting programs displayed on the display portion.

5. An information recording apparatus comprising:
the timer reservation device according to claim 1; and
a timer recording portion for recording information on a recording medium at the time reserved by the timer reservation device.

6. An information recording apparatus comprising:
a timer reservation device: and
a timer recording portion for recording information on a recording medium at the time reserved by the timer reservation device, wherein
the timer reservation device includes
an input portion for entering items that are necessary for timer reservation,
a timer reservation setting portion for performing the timer reservation based on input by the input portion,
a broadcasting program obtaining portion for obtaining broadcasting programs,
a control portion for extracting broadcasting programs that match entered contents from broadcasting programs obtained by the broadcasting program obtaining portion when any one of items that are necessary for the timer reservation is entered by the input portion so as to make a display portion display the same, and for extracting broadcasting programs in each case when an item that is necessary for the timer reservation is added by the input portion and makes the display portion display the extracted broadcasting programs that match entered contents till the moment,
a selecting portion for selecting a program from broadcasting programs displayed on the display portion, and
a selected program reservation setting portion for performing reservation of the selected program when the program is selected by the selecting portion from broadcasting programs displayed on the display portion.
